(19) United States
(12) Patent Application Publication
(10) Pub. No.: US 2008/0127754 A1
(43) Pub. Date: Jun. 5, 2008

(54) Thin-film detecting device

(76) Inventors: Chi-Yuan Lee, Jhonghe City (TW); Shuo-Jen Lee, Yonghe City (TW); Chin-Hua Wu, Jhongli City (TW); Guan-Wei Wu, Su-ao Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/907,141

(22) Filed: Oct. 10, 2007

(30) Foreign Application Priority Data
Nov. 30, 2006 (TW) 095144547

(51) Int. Cl. G01M 19/00

(52) U.S. Cl. 73/865.8

(57) ABSTRACT

A thin-film detecting device includes a plate set and a thin-film detecting portion especially for fuel cell, steam reformer and the like. This plate set has a first plate and a second plate. Each first plate has an inner surface, an outer surface, at least one channel, a gas inlet and a gas outlet. The thin-film detecting portion is disposed between the first plate and the second plate. This thin-film detecting portion is deformable and has at least one sensor. Each sensor has a connecting line extending from the sensor to a controller. About this invention, its structure is simple. It is easy to install. The exchangeability is high. And, it can be disposed on a specific position easily.

### BACKGROUND OF THE INVENTION

1. Field of the Invention

The present invention relates to a thin-film detecting device. Particularly, it relates to a thin-film detecting device having a thin-film detecting portion disposed between two plates. About this invention, its structure is simple. It is easy to install. The exchangeability is high. Plus, it can be disposed on a specific position easily.

2. Description of the Prior Art

With regard to a traditional fuel cell, it is possible to install a sensor at the entrance or exit of the fuel cell. Although it can detect the temperature, humidity, pressure and CO concentration at that point (at the entrance or at the exit), it cannot directly detect the actual condition of a channel inside this fuel cell.

Some fuel cell manufacturer tried to install one or more sensors on one of the bipolar plates of the tradition fuel cell during the manufacturing process. But, it still faces the following difficulties or problems:

[1] The structure is complicated. There are many complicated types of flowing channels on the bipolar plates. Once the design of the channel is different, the manufacturing procedures to install sensors on the bipolar plate will be totally changed. Thus, the structure is complicated

[2] The installing process is inconvenient. For such conventional fuel cell, it is required to install all sensors during the manufacturing process. Once the fuel cell is finished, it is almost impossible (or highly difficult) to add any extra sensor inside. Therefore, it cannot to put in or take out some sensors after this fuel cell is made.

[3] There is no exchangeability at all. In the past, the sensors are directly made (such as coated) on the bipolar plate. These sensors are fixed on it. It is impossible to take our one of these installed sensors out to move to another fuel cell. Hence, there is no exchangeability at all.

[4] The manufacturing process for installing the sensors inside is very complicated. Assuming the length of the curvy channel inside the fuel cell is 25 cm, if four sensors are designed to be secured on the positions at 7 cm, 14 cm, 18 cm, and 25 cm measuring from the entrance, it is quite difficult to arrange all these sensors during the manufacturing process. In addition, eight connecting lines for these four sensors must be disposed inside. Installing these eight connecting lines is another problem during the manufacturing process. Besides, if any one of the sensors is out of order, it is extremely difficult to fix it. Usually, the entire fuel cell will be abandoned.

### SUMMARY OF THE INVENTION

The primary object of the present invention is to provide a thin-film detecting device. In which, its structure is simple.

The next object of the present invention is to provide a thin-film detecting device. It is easy to install.

The other object of the present invention is to provide a thin-film detecting device. The exchangeability is high, so that its industrial applicability is high.

Another object of the present invention is to provide a thin-film detecting device. It can be disposed on a specific position easily.

### BRIEF DESCRIPTION OF THE DRAWINGS

FIG. 1 is a perspective view of the first preferred embodiment of the present invention when it is disassembled.

FIG. 2 is a cross-sectional view of a selected portion of the second preferred embedment of the present invention.

FIG. 3 is a cross-sectional view of a selected portion of the third preferred embodiment of the present invention.

FIG. 4 illustrates the third preferred embodiment of the present invention before assembling.

FIG. 5 is a view showing the third preferred embodiment of the present invention after assembling.

FIG. 6 is a front view showing the internal condition of the third preferred embodiment of the present invention after assembling.

FIG. 7 is a view showing the fourth preferred embodiment of the present invention.

FIG. 8 is a view illustrating the fifth preferred embodiment of the present invention.

FIG. 9 is a cross-sectional view of a selected portion of the fifth preferred embodiment of the present invention.

FIG. 10 shows the sixth preferred embodiment of the present invention.

### DETAILED DESCRIPTION OF THE PREFERRED EMBODIMENT

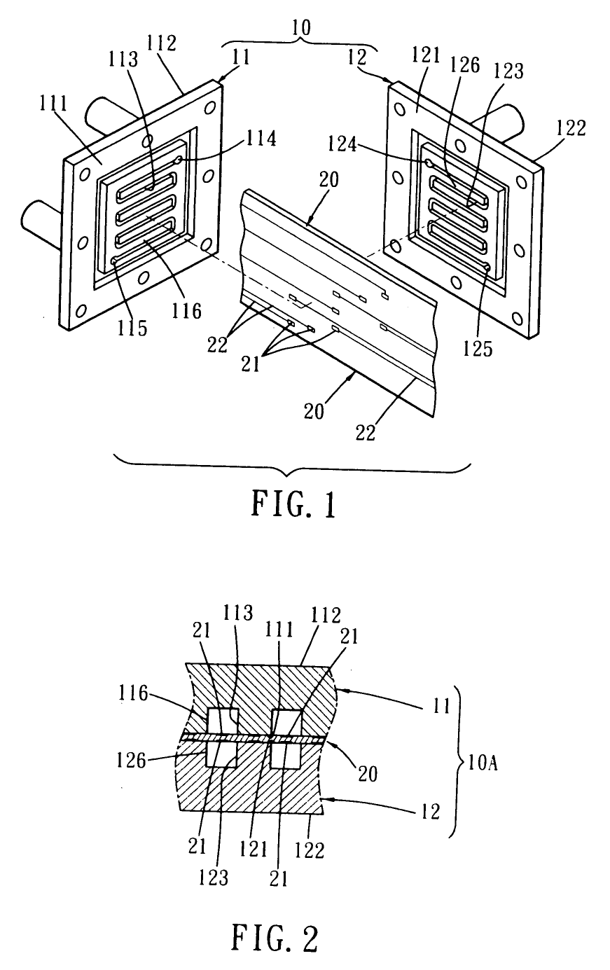

Referring to FIGS. 1 and 2, the present invention relates to a thin-film detecting device. It mainly comprises a plate set 10 and at least one thin-film detecting portion 20.

With regard to this plate set 10, it has a first plate 11 and a second plate 12. About this first plate 11, it includes a first inner surface 111, a first outer surface 112, at least one first channel 113, a first gas inlet 114 and a first gas outlet 115. The first gas inlet 114 and the first gas outlet 115 communicate with the first inner surface 111 and the first outer surface 112.

Concerning this second plate 12, it includes a second inner surface 121, a second outer surface 122, at least one second channel 123, a second gas inlet 124 and a second gas outlet 125. The second gas inlet 124 and the second gas outlet 125 communicate with the second inner surface 121 and said second outer surface 122.

The thin-film detecting portion 20 is disposed between the first inner surface 111 and the second inner surface 121. The thin-film detecting portion 20 (such as a tape structure) is deformable and is disposed with at least one sensor 21. Each sensor 21 has a connecting line 22 extending from the sensor 20.

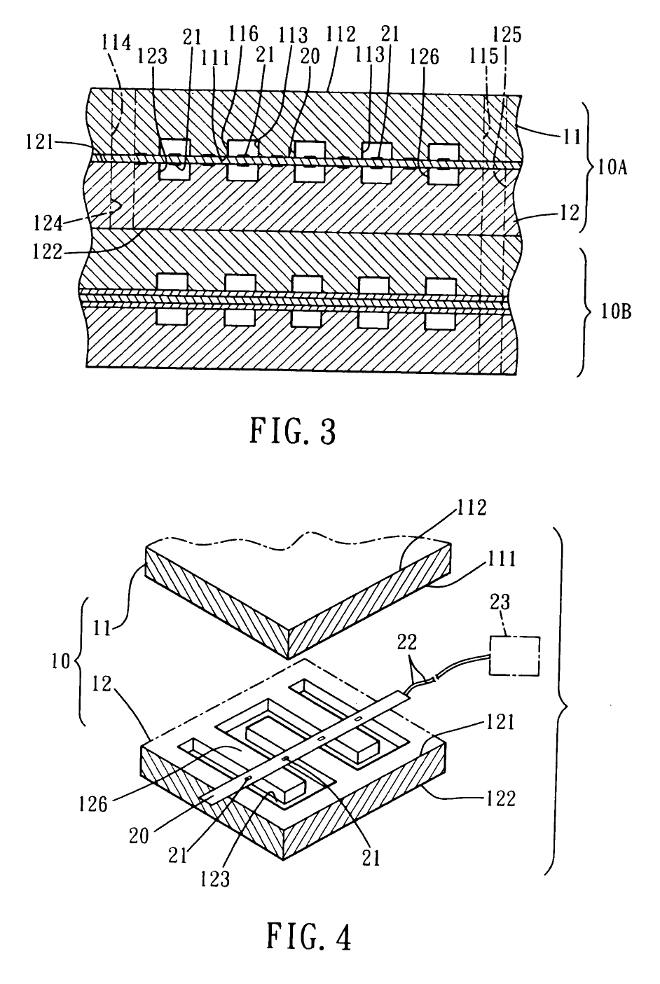

Practically, the plate set 10 can be applied on a steam reformer (as shown in FIG. 2 and labeled as 10A) for generating hydrogen (H₂) or applied on a fuel cell (as shown in FIG. 3 and labeled as 10B) combined with a steam reformer (as seen in FIG. 2 and labeled as 10B to avoid any confusion).

As illustrated in FIGS. 2 and 3, the first plate 11 is disposed with several first channels 113 (connected as a long curvy channel) and several first separating blocks 116. In the cross-sectional view of FIG. 3, each first separating block 116 is disposed two neighboring parallel first channels 113. Similarly, the second plate 12 is disposed with several second channels 123 (also connected as a long curvy channel) and several second separating blocks 126. Each second separating block 126 is disposed two neighboring parallel second channels 123. By this design, it can significantly increases the chemical reacting area for gasses.

It can be seen in FIG. 4, one narrow thin-film detecting portion 20 is disposed inside the plate set 10 (like the concept of sandwich). Of course, as shown in FIG. 7, two thin-film detecting portions 20 at two desired positions can be disposed inside the plate set 10. Thus, this invention can detect more accurate and precise information inside this plate set 10.

Referring FIG. 4, this thin-film detecting portion 20 is disposed with at least one sensor 20. Each sensor 20 has a connecting line 22 extending from the sensor 20 so as to connect to a controller 23 for detecting the actual condition and/or dada (like temperature, humidity, pressure, CO concentration, etc.) inside the plate set 10 (such as a steam reformer, fuel cell, or the like).

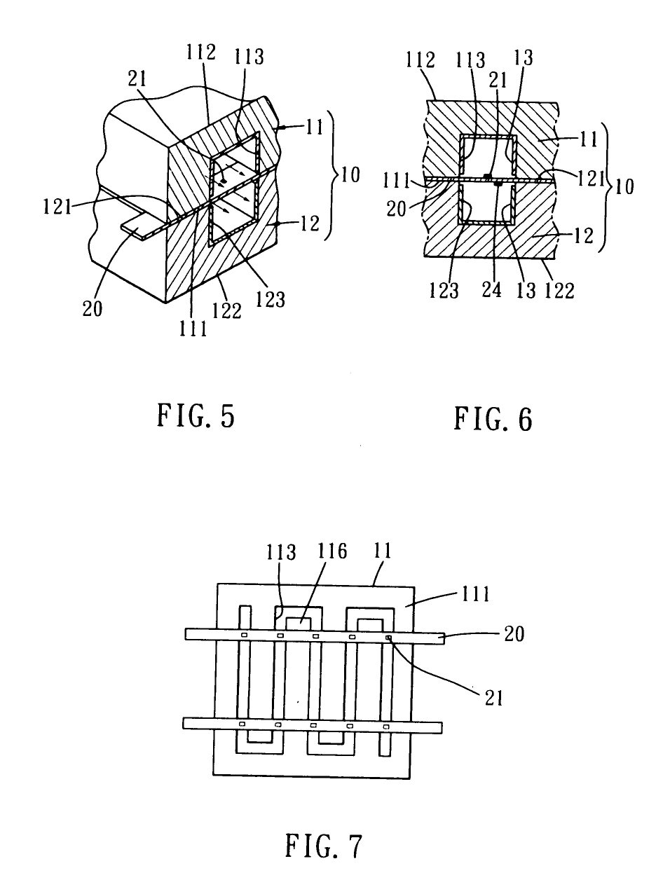

Referring to FIGS. 5 and 6, the thin-film detecting portion 20 has been pulled into a straight thin tape structure and then is disposed between the first plate 11 and the second plate 12. The sensor 21 on the thin-film detecting portion 20 is just suspended at the middle of the space consisting by the first channel 113 and the second channel 123. Under the circumstances, the thin-film detecting portion 20 does not contact with the inner walls of the first channel 113 and the second channel 123 for preventing any influence on its detecting accuracy or precision caused by the inner walls. In addition, because the sensor 21 is positioned at the middle of flowing field, it can detect the real condition for the flowing gas or fluid more precisely (such as for temperature, humidity, pressure, CO concentration, etc.). Besides, since the thickness of the thin-film detecting portion 20 is extremely thin (like a tape or thinner), it almost will not interfere the flowing state nor cause any turbulence inside. Therefore, the detected information will be more accurate and more precise.

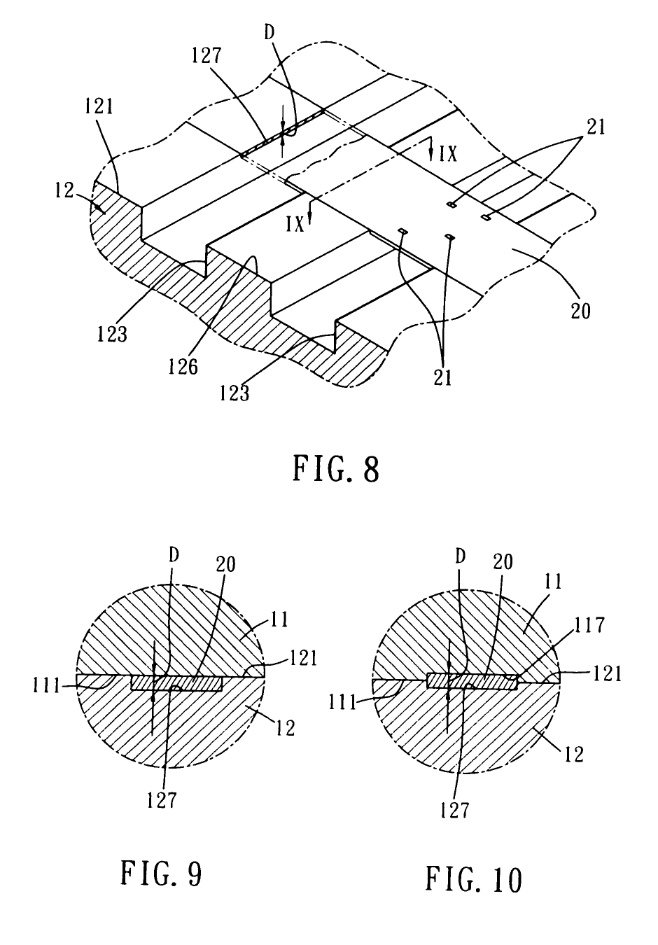

As illustrated in FIGS. 8 and 9, since the thin-film detecting portion 20 is very thin and deformable, it can be placed to a desired position on a plate (such as on the second plate 12). The thin-film detecting portion 20 has a predetermined thickness D (might be from 1 μm to 100 μm). However, it can be directly placed on the second inner surface 121 of the second plate 12, there is a second shallow recess 127 formed on the second inner surface 121 for receiving the thin-film detecting portion 20. Hence, the first inner surface 111 and the second inner surface 121 still can contact each other firmly.

As shown in FIG. 10, if a first shallow recess 117 is formed on the first plate 11, the first shallow 117 and the second shallow recess 127 can form a combined space for receiving the thin-film detecting portion 20. Also, the first inner surface 111 and the second inner surface 121 still can contact each other firmly. Such modification is still within the protecting scope of this invention.

Furthermore, except installing the sensors 21 to obtain the information of the actual condition in the channel (such as temperature, humidity, pressure, CO concentration, etc.), one or more heating elements 24 (as illustrated in FIG. 6) can be added on the thin-film detecting portion 20. These heating elements 24 are connected by one or more connecting lines 22 and then controlled by the controller 23 (can be seen in FIG. 4). Based on the information (temperature, humidity, pressure, CO concentration, etc.) detected by the sensors 21, the controller 23 can determine to turn on or turn off predetermined heating elements 24. By adding a suitable amount of heat inside, the catalytic portion 13 disposed on the first channel 13 (as shown in FIGS. 5 and 6) will be maintained at an optimal reacting temperature (with optimal reaction environment).

The advantages and functions of the present invention can be summarized as follows:

[1] Its structure is simple. By utilizing the thin and deformable characteristics of the thin-film detecting portion, it can be easily disposed between two plates. Tiny sensors are disposed on this thin-film detecting portion for detecting the actual condition inside. The structure of this invention is very simple.

[2] It is easy to install. In order to know the information of temperature, humidity, pressure and CO concentration inside a fuel cell or a steam reformer, the user just needs to open the plate set and then place the thin-film detecting portion (at a desired position) between the first plate and the second plate. No modification for the plate set is required. Thus, the installing word is extremely easy.

[3] The exchangeability is high. Since the thin-film detecting portion is a tape structure design, one or more thin-film detecting portions can be placed on a desired position inside a fuel cell or a steam reformer (no matter their sizes or shapes are different). Thus, the exchangeability is high.

[4] It can be disposed on a specific position easily. If the user wants to detect specific positions (four detecting points) in a channel at 1 cm, 5 cm, 10 cm, and 15 cm measuring from the entrance of the channel, the user can install a thin-film detecting portion having four sensors just matching these specific positions and then assemble the first plate and the second plate. However, if the user wants to change these detecting points at 3 cm, 7 cm, 13 cm, and 18 cm measuring from the entrance of the channel, the user only needs to open the plate set and then re-adjust the thin-film detecting portion or replace a new one instead. Therefore, it can be disposed on a specific position easily.

The above embodiments are only used to illustrate the present invention, not intended to limit the scope thereof. Many modifications of the above embodiments can be made without departing from the spirit of the present invention.

What is claimed is:

1. A thin-film detecting device comprising:
a plate set having a first plate and a second plate, said first plate including a first inner surface, a first outer surface, at least one first channel, a first gas inlet and a first gas outlet; said first gas inlet and said first gas outlet communicating with said first inner surface and said first outer surface; said second plate including a second inner surface, a second outer surface, at least one second channel, a second gas inlet and a second gas outlet; said second gas inlet and said second gas outlet communicating with said second inner surface and said second outer surface; and
at least one thin-film detecting portion disposed between said first inner surface and said second inner surface, said thin-film detecting portion being deformable and being disposed with at least one sensor, each sensor having a connecting line extending from said sensor.

2. The thin-film detecting device as claimed in claim 1, wherein said the first plate being disposed with several first channels and several first separating blocks, each first separating block being disposed between two neighboring parallel first channels; and said second plate being disposed with several second channel and several second separating blocks, each second separating block being disposed between two neighboring parallel second channels.

3. The thin-film detecting device as claimed in claim 1, wherein said thin-film detecting portion is disposed with at least one sensor, and each sensor has a connecting line extending from the sensor so as to connect to a controller.

4. The thin-film detecting device as claimed in claim 1, wherein at least one heating element is disposed on the thin-film detecting portion and connect with a controller.

5. The thin-film detecting device as claimed in claim 1, wherein said thin-film detecting portion has a predetermined thickness D, and a shallow recess is formed on one or both of the plate set for receiving said thin-film detecting portion.

6. The thin-film detecting device as claimed in claim 5, wherein said shallow recess is formed on one or both of said first inner surface an said second inner surface.
